(19) United States
(12) Patent Application Publication
(10) Pub. No.: US 2004/0030934 A1
(43) Pub. Date: Feb. 12, 2004

(54) User selectable authentication interface and universal password oracle

(76) Inventors: Fumio Mizoguchi, Tokyo (JP); Wu Wen, Sunnyvale, CA (US)

Correspondence Address: PAUL A. GUSS, PAUL A. GUSS ATTORNEY AT LAW, 775 S 23RD ST FIRST FLOOR SUITE 2, ARLINGTON, VA, 22202

(21) Appl. No.: 10/398,774

(22) PCT Filed: Oct. 19, 2001
(86) PCT No.: PCT/US01/32604

(51) Int. Cl. H04L 9/32

(52) U.S. Cl. 713/202

(57) ABSTRACT

A password interface application (1) presents successive arrays of images or other sensory cues (4) for display or playback on a client device. A user selects, or simply recognizes, one object from each of the successively presented arrays, wherein after recognizing the object subsequent arrays are presented for defining a complete password. Unlike image based authentication systems in which a graphic method merely replaces original username/password pair authentication, a client system is used which helps a user to recall a forgotten password without requiring modification to server software, such as a secure web server (3). Thus existing ATMs (2), online or telephone banking services, and the like, can function as is. The system provides enhanced security because, although people can possibly eavesdrop on the images or sensory cues selected, they cannot see into the user's mind to comprehend the password that the user recognizes.

### CROSS-REFERENCE TO RELATED APPLICATIONS

This application claims priority from U.S. Provisional Application Serial No. 60/241,329 filed on Oct. 19, 2000 by Wu Wen and Fumio Mizoguchi, and the entire disclosure of this provisional application is expressly incorporated herein by reference.

### BACKGROUND OF THE INVENTION

1. Field of the Invention

The present invention relates to user authentication schemes for permitting access to secure data environments on the Internet or for gaining access to networked environments using computers, PDAs, Pocket PCs, and other communication devices such as cellular phones and the like. The invention also concerns visual, auditory or other sensory based memory aids for recalling passwords, or more precisely, for eliminating the need to remember passwords altogether.

2. Description of the Related Art

Many computer systems currently require input of a password or username/password pair to enable access to data and information handled by the computer system. For example, in the ubiquitous Windows networking environment, a user is presented with a logon dialog box upon startup of a personal computer, where the user enters a chosen username (typically the username is already displayed) and a password to permit access to the network. In addition, various websites accessible through Internet browsers require passwords in order to gain access to services, information and data offered through secure websites. Such websites provide services ranging from online email accounts, online auctions, as well as access to online banking services including the ability to access account information, make payments, online stock trades and so forth. Other services, for example ATM machines or telephone banking, enable access to account information and transactions by inputting a personal identification number or PIN.

As we move into the digital age, many of the interactions we have with others, machines, institutions and other entities need to be protected by security measures. Various complex mathematical models, software, infrastructure, hardware, and even human anatomical features are used to achieve this purpose. Examples are cryptographic protocols, secure socket layer (SSL), public key infrastructure (PKI), smart cards and biometrics. However, these so called “strong” security procedures often depend on a single human memorized password or pass-phrase.

Reliance on alphanumeric passwords or username/password pairs leads to several disadvantages. First, there is the need to remember passwords, a disadvantage which is exacerbated as the number of user accounts increases. For example, a user may be required to recall passwords not only for computer or Internet access, but also for various different websites accessed through the computer, PIN numbers for multiple banking and stock trading accounts, online auction accounts, and so forth. Moreover, because of the need to remember so many passwords for so many different uses, users are often tempted to use the same password for all of the secure environments they wish to access, which can lead to a weakening of security, since if the password used at one site is compromised all of the sites become compromised simultaneously.

On the other hand, it is by no means easy or practical for users to memorize and recall multiple alphanumeric passwords for different sites and services they need to access. Faced with such a burden, human nature leads to users writing their passwords down on paper as memory aids, or on notes attached to their computer terminals. A further problem results from the fact that, because the human memory burden is so high, users often choose short or easy to remember passwords which are more susceptible to cracking.

As an alternative to memorizing alphanumeric passwords, uses of images for user authentication have been proposed. Dhamija and Perrig, “Déjà vu: A User Study Using Images for Authentication, SIMS/CS, Univ. of Calif. Berkeley,” 9th USENIX Security Symposium, pp. 45-56, (August 2000), disclose a system which authenticates users through their ability to recognize previously learned images. More specifically, after a training phase in which a user learns images to make up her user portfolio, a challenge set of images are presented which consists of portfolio images and decoy images. If the user correctly identifies the subset of all portfolio images from within the challenge set, she is authenticated. U.S. Pat. No. 5,559,961 to Blonder discloses a graphical password in which several features taken from a single image, such as the eyes and ears of a horse's head, are selected as “tap regions” and used to record information specific to a particular user for providing access to a protected resource. Other known authentication systems, as alternatives to alphanumeric strings, have been discussed in the cross-referenced Provisional Application referred to above.

The above known systems tend to be server based. Thus, one criticism of Dhamija and Perrig's approach has been the need for a server to store a large number of images. Moreover, in this system, the user is presented with one large single collection of images, from which the user has to select a subset of portfolio images from among other random decoy images. Thus, in Dhamija and Perrig's approach, as well as Blonder's, the display of an image or images is presented but once, so that the user either has to select images out of a large set images or select regions from within one large image. There is no user-friendly prompting which guides the user through the selection process.

### SUMMARY OF THE INVENION

The present invention is based on the extraordinary ability of humans to recognize and recall objects such as images, faces and sounds almost effortlessly, and in particular, offers an object-based password entry system which replaces the need for a user to memorize passwords.

To overcome the drawbacks of the known systems discussed above, the invention provides a password mapping interface application which produces successive arrays of images for display on a client device. The user selects one image from each of the successively displayed arrays, wherein selecting one recognized image from within an array prompts the display of a subsequent array, until all of the successive arrays of images needed for defining the password have been displayed.

The selected images are mapped to an alphanumeric password or username/password pair, wherein the alphanumeric form of the password need not be remembered or even known to the user. The alphanumeric data, which is derived from the user-selected images, is supplied to a password-enabled information processing environment, as a secure destination, to enable access to the secure environment.

A further embodiment of the invention is directed to a handheld device, called a password oracle, which stores and executes a program based on the same principles described above, and which consists of a display images in consecutively displayed arrays, each image being displayed along with a numeric or alphabetical tag. The user can thereby recall a PIN number or password by recognizing the object and finding the number or alphabetical character tagged to the object, thereby recalling a PIN number or password as needed. The password oracle, though not intended for direct connection to a networked environment, serves as a memory jogger so that a user's passwords need not be consciously remembered. At the same time, the oracle is useless to anyone but its owner who is familiar with the images that define the PIN or password, so that even if the oracle falls into the wrong hands, security is not compromised.

The above and other objects, features and advantages of the present invention will become apparent from the following description when taken in conjunction with the accompanying drawings in which preferred embodiments of the present invention are shown by way of illustrative example.

### BRIEF DESCRIPTION OF THE DRAWINGS

FIG. 1 illustrates a basic and overall system architecture under which the present invention is implemented;

FIGS. 2(A) to 2(D) illustrate a concrete example of how the password mapping interface application of FIG. 1 is used in practice;

FIGS. 3(A) to 3(C) illustrate variations on the embodiment of the password mapping interface shown in FIGS. 2(A) to 2(D);

FIG. 4 shows a typical browser environment and the password mapping interface application, illustrating one way in which the present invention may be used to provide access to a secure destination site; and

FIG. 5 illustrates a further use of the graphical password application installed on a PDA device, for explaining the features of a password oracle device used for recalling user passwords.

### DETAILED DESCRIPTION OF PREFERRED EMBODIMENTS

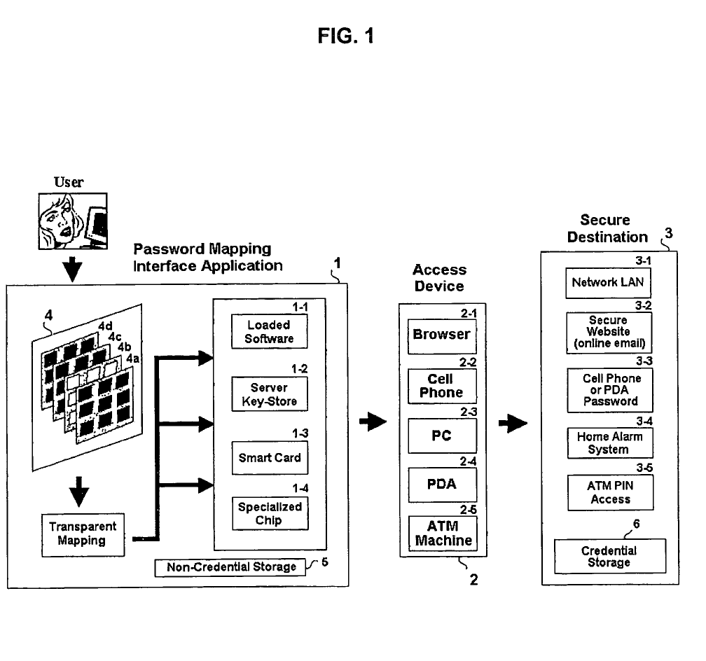

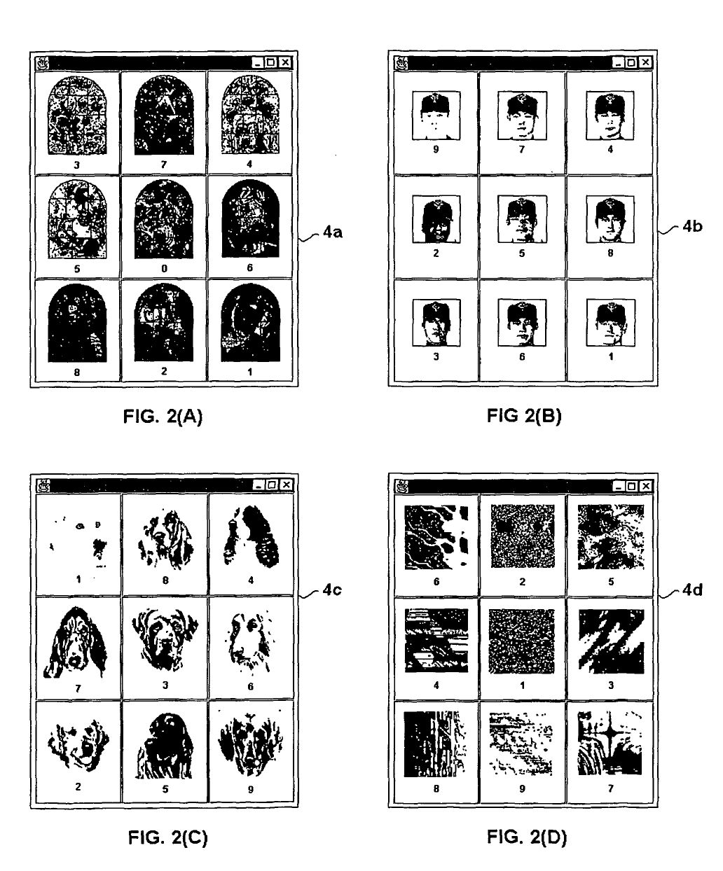

FIG. 1 illustrates a basic and overall system architecture under which the present invention is implemented. The invention is explained in the context of user-selected visual images, which are presented as choices in sequence for the user to select, as shall be explained later in FIGS. 2(A) to 2(D). The invention, however, may also be applicable to the selection of non-visual cues, such as selecting sounds from a plurality of sets of auditory cues presented in sequence, for example. Thus, the term “array” as it is used in the claims is intended to encompass any ordered arrangement and the term is applicable to sensory cues apart from visual images.

The client-based software of the present invention is a password mapping interface application 1 which can be implemented in numerous different forms independent of any given hardware. The interface application 1 enables user selection of images from image frames 4a, 4b, 4c and 4d that are displayed sequentially on a display 4, as well as mapping information of the selected images to a password or username/password pair.

One exemplary implementation is on a client machine, such as a personal computer, wherein the interface application 1 is provided on the machine as loaded software 1-1 in a Java application or the like. A second example is to use the application in conjunction with a server key-store 1-2 which stores user passwords, wherein the interface application 1 accesses the server key-store 1-2 for fetching passwords or username/password pairs to be transferred to a secure destination 3 through the interface application 1. A third example is to embody the interface application 1 on a smart card, wherein the smart card can include both the application software (the interface application 1 may be flashed onto the smart card in a known manner) and the password or username/password pairs necessary for enabling access at the secure destination 3. A fourth example is to use a specialized chip 1-4 which can be embodied in the client machine and which, likewise, includes both the interface application software 1 (the application can be hard coded into the chip in a known manner) and the password or username/password pairs necessary for enabling access to the secure destination 3. It shall be understood that the above examples are non-limiting, and that other implementations of the password mapping interface application 1 would be easily understood by persons skilled in the art.

In all of the above examples, the machine or device executing the password interface application 1 stores or accesses from a non-credential storage means 5 only non-credential (i.e. non-sensitive) information and thus, for example, the client machine or device should contain no stored information such as credit card numbers, bank account numbers, banking balances or the like. In other words, the interface application 1 utilizes only minimal data necessary to map information of the images selected from successive displays 4a-4d to the alphanumeric based password or username/password pair, which is then transmitted to the secure destination 3 using any of various access devices 2 through which access to a desired secure destination 3 is enabled.

The password mapping interface application 1 enables access to a secure destination 3 though an access device 2. Again, the access device 2 is not limited to any particular device but may comprise any of several well known devices in use today. The invention works by launching the interface application 1 on the access device 2.

As one example, the access device 2 may comprise a browser application 2-1, such as the Microsoft Internet Explorer, loaded on the user's personal computer. In this case, when the user uses the browser to access a secure or password-enabled website, for example an online email service, such an action causes the interface application also loaded on the client machine to initiate popping up of the display 4. The alphanumeric password or username/password pair also is passed to the online email service through the password interface 1, for example, via generated HTTP request headers.

As another example, in the event the access device 2 comprises an internet-enabled cell phone 2-2, a specialized chip containing the interface application can be embedded in the cell phone circuitry. In this case, when the user desires to use the cell phone to access a service, for example with an Internet enabled I-mode phone or the like, the password interface will be initiated on the cell phone LCD display, whereby the user can enter a graphical password via the display 4.

As still another example, the password mapping interface application 1 may be embodied on a smart card 1-3 or PCMCIA card which is inserted into a PC 2-3 for enabling access to a network or LAN to which the PC is connected and to which access is desired. In this case, by insertion of the smart card 1-3 into the PC 2-3, the interface application 1 is launched, so that the first activity the user must perform for gaining access to the LAN is to input his graphical password. In this case, as well, withdrawing the smart card 1-3 from the PC 2-3 will immediately cut off access to the LAN, disabling the PC 2-3 until the card is reinserted and the visual password reentered.

Another example to implement the interface application is to execute it through any of well known PDA or Pocket PC devices 2-4, either by means of loaded software, a specialized chip, or by connection of another auxiliary device, such as a card or module, to the PDA 2-4. In this case, when starting up the PDA 2-4, or when the PDA 2-4 is used for gaining access to various secure destinations, or even for providing basic access to the PDA 2-4 itself, the password interface application 1 is launched.

A last example of an access device 2 is a smart card enabled ATM machine 2-5. In this case, the password interface application 1 is embodied on the smart card 1-3 which serves as the user's banking card, and when the card is inserted into the ATM machine 2-5, the interface application 1 is launched so that, instead of entering a PIN number numerically, the visual interface is used instead.

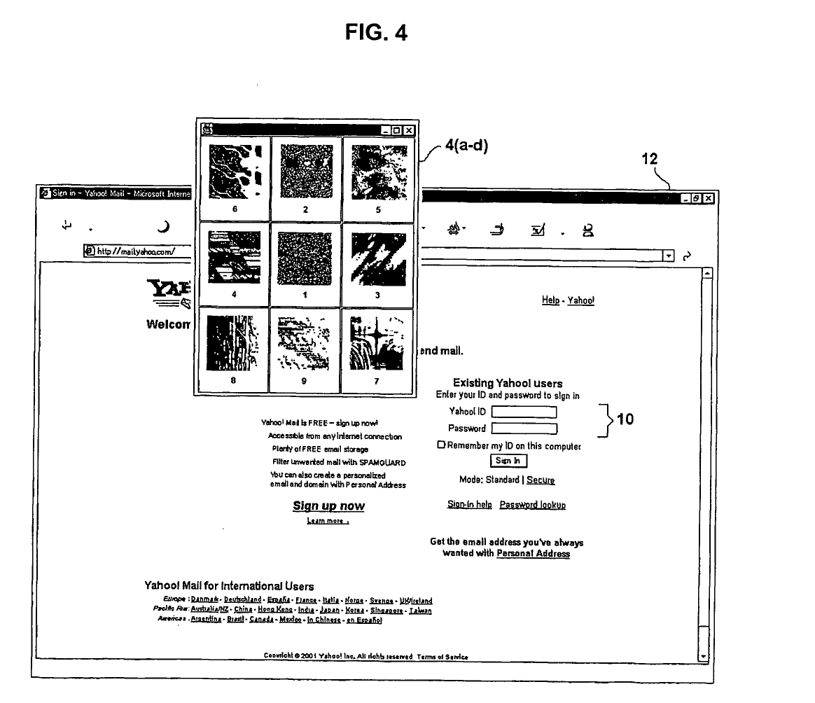

Examples of various secure destinations, some of which have already been alluded to above, are shown at reference numeral 3. One example is a network LAN environment 3-1, wherein the interface application 1 is used for gaining access to a LAN. Another example is a secure website 3-2, which shall be discussed in greater detail later in connection with FIG. 4. Examples of secure websites are online email systems, such as Yahoo Mail and Hotmail, online banking or stock trading services, online auctions, etc., most of which use the SSL (secure socket layer) and require a username and password for access. Another example is to provide cell phone or PDA password access 3-3. Such handheld devices can require a password for using the device itself, or in the case of Internet enabled applications, may require passwords for access to certain websites, essentially in the same manner as the browser environment. Another example is a remote operated home alarm or surveillance system 3-4 which can be accessed through a PC or handheld device using a password. A final example is ATM access 3-5 which requires a PIN number for activation and access to account information. Again, it shall be appreciated that these examples are by no means limiting, and that many present and future services can be envisioned which require passwords or username/password pairs, and to which the principles of the present invention are equally applicable. Generally, it is understood that such secure destinations 3 provide access to credential storage 6 in which user sensitive information is stored.

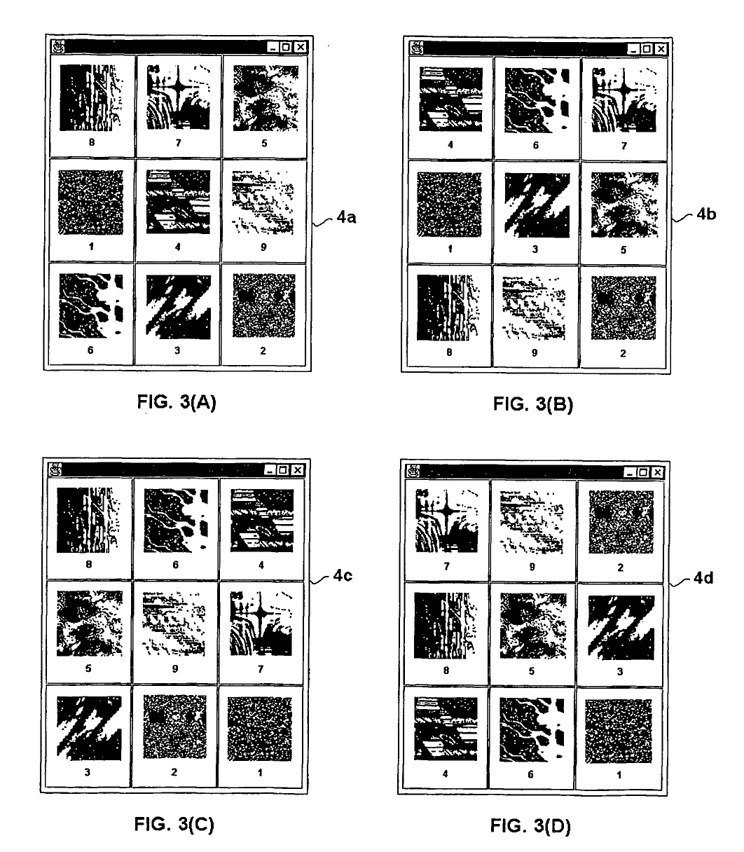

The above examples and explanations should become more clear when considered in conjunction with FIGS. 2(A) to 2(D) and FIGS. 3(A) to 3(D), which show in greater detail how the password mapping interface application 1 is used, and with FIG. 4 which shows a specific implementation for gaining access to an online email service via a web browser.

FIGS. 2(A) to 2(D) illustrate a concrete example of how the password mapping interface application 1 of FIG. 1 is used. For example, one such use is to provide access to a desired secure destination 3, such as an online email service 3-2, wherein the access device 2 through which one gains access to the email service is a web browser 2-1.

A sequence of four consecutively displayed image pads is shown in FIGS. 2(A) to 2(D). The four image pads 4a-4d, each made up of nine images in a 3×3 array, are displayed consecutively on a computer display for the user to see. The computer display may be a computer monitor or an LCD display on a handheld device such as a PDA, cell phone or the like.

Each of the consecutively displayed arrays consists of nine images, wherein a user recognizes (as a result of some initial training) only one of the images out of the nine displayed in each array. Therefore, when the array 4a shown in FIG. 2(A) is displayed, the user may recognize the image above the number 4, for example. When the user selects this image, for example by moving a cursor over the image and clicking on it using a mouse, a subsequent image array 4b as shown FIG. 2(B) is displayed which consists of an array of faces, for example. In this array, the user may recognize the face shown above the number 2, for example. When the user selects this image, a subsequent image array 4c as shown in FIG. 2(C) is displayed, which consists of an array of canine heads, for example. In this array, the user may recognize the dog shown above the number 7, for example. Finally, when the user selects this image, a subsequent image array 4c shown in FIG. 2(D) is displayed which consists of an array of abstract graphic images, for example. In this array, the user may recognize the image shown above the number 7 again, for example, and selects this image which completes user entry of the password.

Hence, in the example above, using image recognition alone, the user is able to recall his password as 4277. In the automated version of the present invention, in contrast to the oracle embodiment, the numbers preferably need not be displayed along with the images. Rather, the user simply selects with the mouse the recognized image from each consecutive array. The underlying interface program maps the user's selections to an alphanumeric password, without the user even having to see or recall the numbers or letters making up the password, wherein the program silently and automatically transfers the alphanumeric password information to the secure destination 3 for which access is desired. An example of such automated operation, for providing access to an online email service, shall be explained later in connection with FIG. 4.

However, first, variations on the embodiment shown in FIGS. 2(A) to 2(D) shall be explained with reference to FIGS. 3(A) to 3(C).

It is not necessary that the consecutively displayed image arrays 4a-4d comprise different types of images, like abstract art, faces, dogs, abstract graphics, etc., as shown in FIGS. 2(A) to 2(D). Rather, the consecutive arrays 4a-4d can all be made up of the same types of images. As shown in FIGS. 3(A) to 3(D), each of the consecutive arrays 4a-4d can all comprise abstract graphic images. In this case, the user is aware of four images out of the nine that are displayed, but is also aware of the order of the images making up his graphical password. For example, in the first displayed array 4a shown in FIG. 3(A), the user may be aware that the image above number 4 makes up the first image, the image above number 2 makes up the second image, the image above number 7 makes up the third image, and so forth, of his graphical password. However, as the interface program is executed, when the first array 4a is displayed as shown in FIG. 3(A), the user selects the image above number 4 by clicking on it using a mouse, for example, and this action prompts the display of the second array 4b shown in FIG. 3(B) and so on. In the subsequently displayed arrays 4a-4d the images are shuffled each time in a random manner. Such random shuffling makes it much less likely for a malicious onlooker to grasp or remember the images that are being selected by the user.

Again, it should be noted that in the case of an automated logon, display of numbers beneath the images is actually unnecessary (the display of numbers or alphabetical characters is more pertinent to the oracle device to be discussed later on), because the user already recognizes the images that make up his graphical password, and can easily know which images to select without seeing any numbers. The correlation or mapping of the selected images to the alphanumeric password is handled transparently by the interface application 1, which then supplies the password to the secure destination for gaining access, as shall be explained more clearly in connection with FIG. 4.

Another easily understood variation is that the set of all images, including the user-recognizable images and decoy images, can be much larger than the nine images shown in FIGS. 3(A) to 3(D). The only requirement is that at least one user-recognizable image must be displayed in each of the consecutively displayed arrays. In addition, although a 3×3 array is shown in the exemplary embodiments, larger or smaller arrays are possible. Further, the term “array” should be understood to refer not only to a grid-type array as shown in the embodiments, but any ordered arrangement of images presented as consecutively displayed sets, from which the user selects one image per set.

FIG. 4 shows a typical browser environment 12 which is one way in which the present invention is used. When a user is about to enter his or her password to access a secure area, such as an online email or so called “webmail” account, the image pad 4a is displayed. Instead of inputting his username (or user ID) and alphanumeric password into the text input areas 10 provided on the logon page displayed in the browser 12, the user selects one of the images which he recognizes from the image pad 4a. Once an image is selected, consecutive image pads 4b-4d are displayed in the same manner discussed in FIGS. 2(A) to 2 (D) and FIGS. 3(A) to 3 (D), and the user selects the recognized image from the next image pad 4b, and so forth, consecutive image pads being displayed until the user has selected a pre-learned sequence of images from the consecutively displayed image pads.

The selected images are then mapped to the user's username ID and password pair which would ordinarily have been entered in the text input areas 10 provided in the browser window 12. The username/password pair is passed to the secure site through the socket layer as HTTP request headers, just as if the user had entered them into the provided text areas 10 and clicked on the “Sign In” button. In other words, the HTTP request headers and encoded data (encoded and transmitted to the server using, e.g., GET or POST methods) including the username, password, and any other information expected by the secure site such as cookies are generated by the password mapping interface, i.e., the interface application 1 has been pre-configured to send the necessary HTTP request headers and encoded data to the secure server when the correct sequence of images is selected by the user. When the expected request headers and data are received by the secure server, the server returns the next HTML page to the browser 12 which enables access to the user's email account, just as if the information had been sent by the text areas 10 and clicking of the “Sign In” button. All functions on the server side which provide webmail access operate as usual and independently of the password interface application. In fact, the server perceives no difference whether the username and password are entered via the text areas or via the graphical interface.

Although not illustrated in the figures, another potential implementation of the invention uses sounds, for example short musical pieces or tones, as opposed to images. One such implementation could be used for sight-impaired individuals over the telephone. When listening over the telephone receiver, for example, consecutive sets of nine sounds each are played corresponding to numbers on the telephone keypad. In this case, after hearing the first set of sounds, and selecting a recognized sound by means of the appropriate button, a next set of sounds are played, and so forth, until the entire “auditory” password has been entered. Naturally, the same basic concept could be implemented using a sound-generating computer or PDA device and a numeric keypad, for example. Because mapping of the selected sounds is handled the same as mapping of selected images in the graphical embodiments discussed above, the other features of the invention, for providing access to a secure destination 3, are the same.

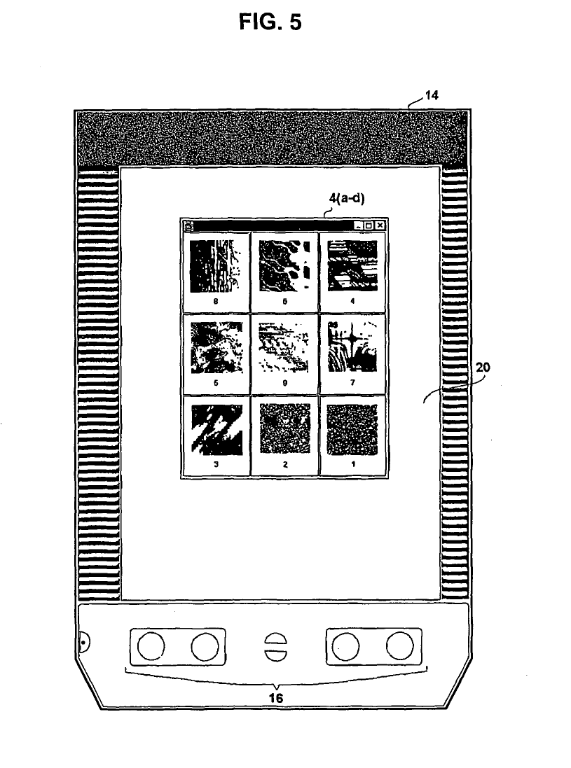

Referring now to FIG. 5, features of a password oracle device used for recalling user passwords shall be explained. FIG. 5 shows essentially the same password interface application described in connection with FIGS. 2(A) to 2(D) and FIGS. 3(A) to 3(D) installed on a PDA device 14, which may be a device running the PalmOS operating system, or a WindowsCE device such as Pocket PC, or any similar portable handheld computing device, including a cellular phone. In addition to a PDA device, the program could be provided on a small LCD display device with minimal processing functions necessary to support the program, attached to a key-ring or the like.

In one use, which has already been described above, since the PDA 14 is itself a computing device enabling connections to secure environments, the password interface can be used essentially in the same manner as a PC, that is, wherein the interface is used for permitting access to secure sites through a browser running on the PDA 14. The password interface can also be used as an initial logon means to permit use of the PDA device, cell phone, etc. as well.

However, another use of the implementation shown in FIG. 5 is as a memory aiding device called a password oracle, which is particularly useful for recalling a PIN number to be entered manually at an ATM machine or via a telephone keypad. In this case, the PDA device 14 per se is not used for establishing a connection with a destination site, but rather serves to remind the user of a password or PIN so that he can enter it manually.

As stated above, operation of the password interface application is basically the same as shown in FIGS. 2(A) to 2(D) and FIGS. 3(A) to 3(D), except that the display of numeric and/or alphabetic tags along with the images is now essential, and no information is generated or transmitted from the password interface to a secure destination. Further, the user is not required to physically select an image by clicking or tapping on it, but simply by flipping through the consecutively displayed image arrays, the user is able to recall a forgotten PIN number. In other words, the selection of images can take place mentally.

For example, referring back to FIGS. 3(A) to 3(D), in frame 4a the image which the user recognizes may occupy a position above a tag showing the number 4 and therefor triggers in the user's mind that the first number of his PIN is 4. The second frame 4b is then displayed, which may be done without actually clicking on a selected image but by pushing any of buttons 16, tapping anywhere on the display 20 with the PDA stylus, or by simply waiting until the next frame appears. In the second frame 4b, the image that the user recognizes is at a position above a tag showing the number 2, triggering recall in the user's mind that the second number of his PIN is two. The third frame 4c appears next and the image the user recognizes is at a position above a tag showing the number 7, triggering recall in the user's mind that the third number of his PIN is seven. The fourth frame appears next and the image the user recognizes is also at a position above a tag showing the number 7, triggering recall in the user's mind that the last number of his PIN is sever. Hence, the user is able to refresh his memory and recall that his PIN number is 4277. All of the recalling takes place solely within the user's mind, so that even if an imposter is watching, the imposter will still have no way of knowing which images the user has recognized. As indicated in FIGS. 3(A) to 3(D), the tag numbers and images may be randomly ordered, and the random ordering (reshuffling) may be different in each consecutively displayed frame. Of course, it is possible to use letters or other alphanumeric characters, or any combination of numbers and alphabetic characters, in addition to numbers alone.

Having securely recalled the forgotten PIN number, the user will then be able to manually enter the number into an ATM machine or telephone keypad, for gaining access to a banking or other computer system. Thus, the password oracle of the present invention serves a memory jogging function for permitting a user to recall a forgotten password through the aid of images which the user is capable of recalling far more easily than an abstract sequence of numbers or letters. Taken further, the invention is based on the assumption that it is potentially dangerous for a user even to attempt to remember his password. Rather, using the password oracle, the user is able to “recognize” the password using visual or other sensory cues without actually knowing it.

The above-described password oracle consists of a display of image portfolios and decoy images on any device that is capable of doing such, and the oracle can be programmed to display the set of images the user chooses. However, although not illustrated, the oracle can also be based on sounds or other sensory outputs, provided that the appropriate devices for accessing such outputs are provided. For example, a telephone can be used to provide a set of sequences of auditory cues, wherein from within each sequence, the user must select a recognized sound. In general, the present invention is not hardware dependent, and any PDA, cell phone, computer screen, kiosks, etc., can be used to host the system.

What is claimed is:

1. A method for enabling access to secure data, comprising the steps of:
providing an interface application, said interface application comprising a plurality of successive arrays of sensory cues for display or playback on a client device;
presenting said arrays of sensory cues successively on said client device; and
recognizing one sensory cue from within each of said successive arrays, as said arrays are presented, wherein after recognizing said one sensory cue, one or more subsequent arrays are presented until all of said successive arrays of sensory cues have been presented.

2. The method according to claim 1, wherein said sensory cues are images which are displayed as successive arrays of images on said client device, further comprising the steps of:
selecting a recognized image from within each of said successive arrays, wherein selecting said one image prompts display of the subsequent array; and
enabling access to a secure information processing environment if a predetermined sequence of images is selected from the successively displayed arrays of images.

3. The method according to claim 2, further comprising the steps of:
converting information of the selected images to alphanumeric data representing at least one of a password or a username/password pair; and
supplying said alphanumeric data to a password-enabled secure information processing environment to enable access to said secure information processing environment.

4. The method according to claim 1, wherein said client device is a personal computer having said interface application and an Internet browser application, and wherein said secure information processing environment is accessed via a website displayed in said browser.

5. The method according to claim 1, wherein said client device is a personal computer having said interface application, and wherein said secure information processing environment is a network environment to which said personal computer connects.

6. The method according to claim 5, further comprising a step of inserting a card medium containing said interface application into said personal computer, wherein said interface application is executed on said personal computer upon insertion of said card medium.

7. The method according to claim 6, wherein said card-medium comprises at least one of a smart card and a PCMCIA card.

8. The method according to claim 1, wherein said client device is one of a portable digital assistant (PDA), a handheld computer, and a cellular phone, which has said interface application installed thereon.

9. A computer readable medium storing instructions making up a password mapping interface application which, when executed by a processor, cause the processor to execute the steps of:
providing a plurality of successive arrays of sensory cues for display or playback;
presenting said arrays of sensory cues successively; and
receiving user input indicating user selection of one sensory cue from within each of said successive arrays, as said arrays are presented, wherein the user selection of one sensory cue within each array prompts presentation of a subsequent array until all of said plurality of arrays of sensory cues have been presented.

10. The computer readable medium according to claim 9, wherein said sensory cues are images, further executing the steps of:
displaying successive arrays of images on a display means;
receiving user input indicating user selection of one recognized image from within each of said successive arrays of images, wherein user selection of said one recognized image prompts display of the subsequent array; and
enabling access to a secure information processing environment if a predetermined sequence of images is selected from the successively displayed arrays of images.

11. The computer readable medium according to claim 10, further executing the steps of:
converting information of the selected images to alphanumeric data representing at least one of a password or a username/password pair; and
supplying said alphanumeric data to a password-enabled secure information processing environment to enable access to said secure information processing environment.

12. An apparatus for recalling a password comprising:
a display screen;
means for successively displaying, on said display screen, a plurality of arrays of images, wherein one image from within each of said arrays is intended for recognition by a user;
means for displaying, alongside each image of each of said arrays, an alphanumeric tag, wherein the alphanumeric tag displayed alongside said one image from within each of said arrays is an element of a user password.

13. The apparatus for recalling a password according to claim 12, further comprising:
user input means for receiving user input, wherein a subsequent array is displayed upon receiving said user input.

14. The apparatus for recalling a password according to claim 12, wherein positions of the images within each of said arrays are randomly assigned at each successive display.
